(19) United States
(12) Patent Application Publication
(10) Pub. No.: US 2022/0124654 A1
(43) Pub. Date: Apr. 21, 2022

(54) TERMINAL AND COMMUNICATION METHOD

(71) Applicant: NTT DOCOMO, INC., Tokyo (JP)

(72) Inventors: Kazuki Takeda, Tokyo (JP); Tooru Uchino, Tokyo (JP); Hideaki Takahashi, Tokyo (JP); Satoshi Nagata, Tokyo (JP); Lihui Wang, Beijing (CN)

(73) Assignee: NTT DOCOMO, INC., Tokyo (JP)

(21) Appl. No.: 17/421,263

(22) PCT Filed: Jan. 9, 2019
(86) PCT No.: PCT/JP2019/000401

§ 371 Date: Jul. 7, 2021

(51) Int. Cl. H04W 56/00; H04W 72/12

(52) U.S. Cl. CPC H04W 56/0015; H04W 72/121

(57) ABSTRACT

A terminal is disclosed including a reception section and a control section. The reception section receives time information that is periodically broadcast or multicast. The control section adjusts synchronization to reference time based on the time information. In another aspect, a communication method performed by a terminal is also disclosed.

### TECHNICAL FIELD

The present disclosure relates to a terminal and a communication method.

### BACKGROUND ART

Long Term Evolution (LTE) has been specified to further achieve a higher data rate, lower latency, and the like in a Universal Mobile Telecommunications System (UMTS) network. Future systems of LTE have also been studied to further achieve a broader bandwidth and a higher speed from LTE. Examples of the future systems of LTE include systems called LTE-Advanced (LTE-A), Future Radio Access (FRA), 5th generation mobile communication system (5G), 5G plus (5G+), Radio Access Technology (New-RAT), New Radio (NR), and the like.

In radio communication systems such as 5G and the like, support for a very high accuracy of synchronization (also referred to as synchronicity, time synchronization, or clock synchronization, for example) such as in the order of 1 μs between devices has been studied (see, for example, Non-Patent Literature (hereinafter referred to as “NPL”) 1).

### CITATION LIST

### Non-Patent Literature

NPL 1

3GPP TR 22.804 V16.1.0, “Study on Communication for Automation in Vertical Domains (Release 16),” September 2018

### SUMMARY OF INVENTION

### Technical Problem

An object of the present disclosure is to improve the synchronization accuracy.

### Solution to Problem

A terminal according to one aspect of the present disclosure includes a reception section that receives time information that is periodically broadcast or multicast, and a control section that adjusts synchronization to reference time based on the time information.

### Advantageous Effects of Invention

According to the present disclosure, the synchronization accuracy can be improved.

### BRIEF DESCRIPTION OF DRAWINGS

FIG. 1 illustrates an example of a configuration of a radio communication system according to one aspect of the present disclosure;

FIG. 2 illustrates an example of a configuration of a base station according to one aspect of the present disclosure;

FIG. 3 illustrates an example of a configuration of a terminal according to one aspect of the present disclosure;

FIG. 4 illustrates an example of performance requirements of a time synchronization service according to one aspect of the present disclosure;

FIG. 5 illustrates a first example of information for configuring a transmission periodicity of System Information (SI) according to one aspect of the present disclosure;

FIG. 6 illustrates a second example of information for configuring the transmission periodicity of the system information according to one aspect of the present disclosure;

FIG. 7 illustrates a first example of the transmission periodicity of the system information according to one aspect of the present disclosure;

FIG. 8 illustrates a second example of the transmission periodicity of the system information according to one aspect of the present disclosure;

FIG. 9 illustrates a third example of the transmission periodicity of the system information according to one aspect of the present disclosure; and

FIG. 10 illustrates an exemplary hardware configuration of the base station and the terminal according to one aspect of the present invention.

### DESCRIPTION OF EMBODIMENTS

Hereinafter, an embodiment of the present disclosure will be described with reference to the accompanying drawings.

Application of 5G systems to various use cases is contemplated. Examples of the use cases include: industrial systems (also referred to as time sensitive networking (TSN), for example) including motion controllers, sensors, or actuators; live performances; smart grids; local conference systems; and the like. These use cases may require stricter requirements of the synchronization accuracy of synchronization between devices (also referred to as User Equipments (UEs), terminals, nodes, or entities, for example) than those in existing systems.

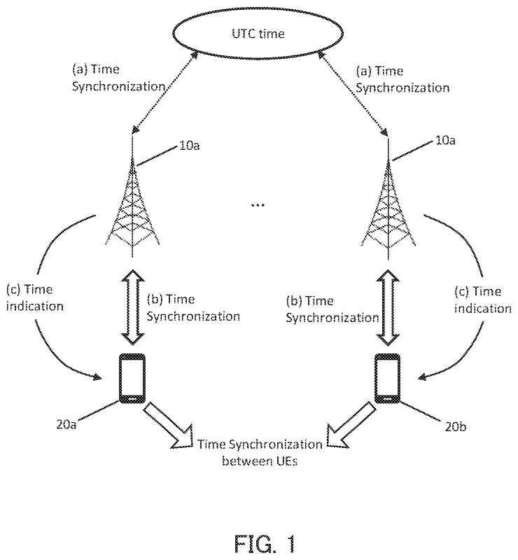

FIG. 1 illustrates an example of a configuration of a radio communication system according to one aspect of the present disclosure.

As illustrated in FIG. 1, the radio communication system includes, for example, base stations (also referred to as gNBs or eNBs, for example) 10a and 10b, and terminals (also referred to as UEs, for example) 20a and 20b. For example, terminal 20a is connected by radio to base station 10a (radio access). For example, terminal 20b is connected by radio to base station 10b (radio access).

Note that the number of base stations and the number of terminals are not limited to two, and may also be one, or three or more. Note also that the configurations of base stations 10 and terminals 20, which will be described later, show examples of functions related to the present embodiment. Base stations 10 and terminals 20 may have functions that are not illustrated. Further, functional divisions or names of functional sections are not limited as long as the functions are for performing operations according to the present embodiment.

Operations for establishing synchronization between terminal 20a and terminal 20b include the following (Operation a), (Operation b), and (Operation c), for example.

(Operation a) Base station 10a and base station 10b obtain time information indicating reference time from a server (not illustrated) and are synchronized to the reference time. Note that FIG. 1 illustrates a case where Universal Time Coordinated (UTC) is used as one example of the reference time. However, the reference time is not limited to UTC, and may also be Global Positioning System (GPS) time, or local time. Note that UTC may be regarded as the same as Greenwich Mean Time (GMT).

(Operation b) Base station 10a and terminal 20a are synchronized with each other based on the reference time to which base station 10a is synchronized. Similarly, base station 10b and terminal 20b are synchronized with each other based on the reference time to which base station 10b is synchronized.

(Operation c) A propagation path between base station 10a and terminal 20a and a propagation path between base station 10b and terminal 20b may be different from each other. A difference existing between the propagation paths between the terminals and the base stations may cause an error in reception timing (in other words, a propagation delay) for the time information at each of the terminals, thereby deteriorating the synchronization accuracy between the terminals. Thus, for example, terminal 20a and terminal 20b perform adjustment (or correction) of the synchronization using adjustment information (for example, a Timing Advance (TA) command to be described below) on the time of which the terminals are notified respectively from base station 10a and base station 10b.

By the above operations, each of terminal 20a and terminal 20b is synchronized to the reference time (e.g., UTC). Terminal 20a and terminal 20b are synchronized to the reference time, so that the synchronization between terminal 20a and terminal 20b is established.

### Configurations of Base Station and Terminal

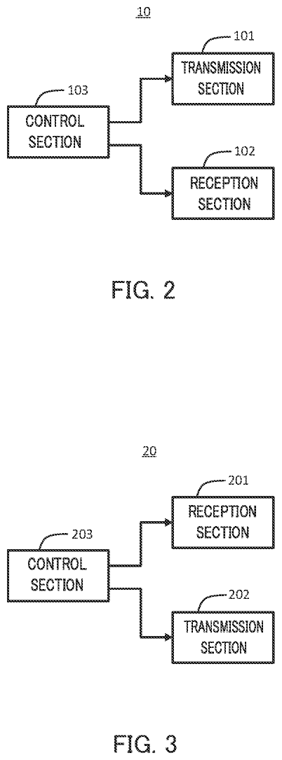

FIG. 2 illustrates an example of a configuration of base station 10 (for example, base station 10a or base station 10b illustrated in FIG. 1) according to the present embodiment. Base station 10 includes transmission section 101, reception section 102, and control section 103, for example.

Transmission section 101 transmits a signal (DL signal) for a terminal to terminal 20. For example, transmission section 101 transmits the DL signal under the control of control section 103.

The DL signal may include, for example, system information including the time information (e.g., System Information Block (SIB) 9 or SIB16), higher layer signaling including the time information, an RA message including the TA command (e.g., RAR), or a MAC CE including the TA command (TA MAC CE). Note that the time information may be replaced with another term such as timing reference information or time reference information.

Reception section 102 receives a signal (UL signal) transmitted from terminal 20. For example, reception section 102 receives the UL signal under the control of control section 103. The UL signal includes, for example, an RA preamble, a measurement report (e.g., Measurement Report) indicating a measurement result of communication quality at terminal 20, channel quality information, a signal of a control channel, a signal of a data channel, a reference signal, or the like. Note that the channel quality information is, for example, channel quality information (CQI). The control channel is, for example, a Physical Uplink Control Channel (PUCCH) and the data channel is, for example, a Physical Uplink Shared Channel (PUSCH). Note also that the reference signal is, for example, a Sounding Reference Signal (SRS).

Control section 103 controls transmission processing of transmission section 101 and reception processing of reception section 102. For example, control section 103 controls transmission processing of transmission section 101. Note that various processes of base station 10, which will be described below, may be implemented by control section 103 controlling transmission section 101 and/or reception section 102.

FIG. 3 illustrates an example of a configuration of terminal 20 (for example, terminal 20a or terminal 20b illustrated in FIG. 1) according to the present embodiment. Terminal 20 includes reception section 201, transmission section 202, and control section 203, for example.

Reception section 201 receives a DL signal transmitted from base station 10. For example, reception section 201 receives the DL signal under the control of control section 203. Note that reception section 201 may directly receive a signal transmitted from another terminal 20 (not illustrated) without via base station 10.

Transmission section 202 transmits a UL signal to base station 10. For example, transmission section 202 transmits the UL signal under the control of control section 203. Note that transmission section 202 may directly transmit a signal addressed to another terminal 20 (not illustrated) without via base station 10.

Control section 203 controls reception processing of reception section 201 and transmission processing of transmission section 202. For example, control section 203 detects time information from the received DL signal. Then, control section 203 causes terminal 20 to be synchronized to the reference time by using the detected time information. Note that various processes of terminal 20, which will be described below, may be implemented by control section 203 controlling transmission section 202 and/or reception section 201.

### Study

Regarding transmission (e.g., broadcast) of the time information in next generation radio communication such as NR and the like, the following will be studied:
An LTE approach is reused for broadcast of the time information using Radio Resource Control (RRC) signaling.
A starting point of time granularity is set to 0.25 μs.

Further, the following will be studied regarding broadcast:
In E-UTRA-NR Dual Connectivity (EN-DC), an NR base station as a Secondary Node (SN) may not broadcast system information different from information on synchronization timing and a System Frame Number (SFN). That is, a UE may receive the system information from an LTE base station (e.g., eNB) and may not receive the system information from the NR base station (e.g., gNB).
EN-DC may support a scenario in which an LTE base station is not synchronized with an NR base station.
In EN-DC by a Master Cell Group (MCG) including an LTE cell and a Secondary Cell Group (SCG) including an NR cell, the system information may be provided to UEs through the LTE base station as a master node by specific RRC signaling.

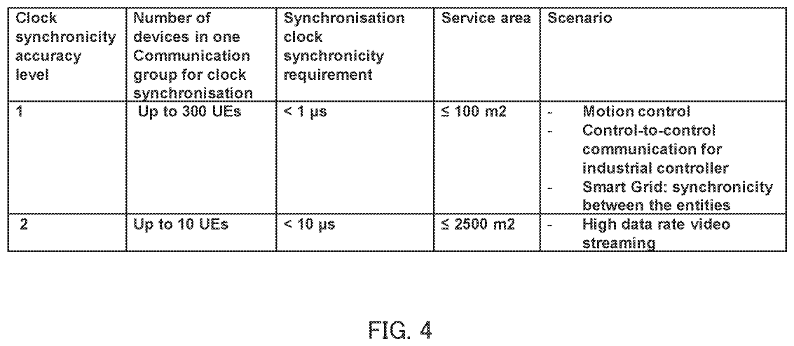

In addition, as illustrated in FIG. 4, the following will be studied regarding performance requirements of the time synchronization service at the clock synchronization accuracy level “1”:
The maximum number of devices in one communication group related to time synchronization is set to 300.
A time synchronization requirement is set to less than 1 μs.
A service area is set to 100 m² at the maximum.
Assumed scenarios include motion control, inter-control communication for industrial controllers, or synchronization between entities in a smart grid.

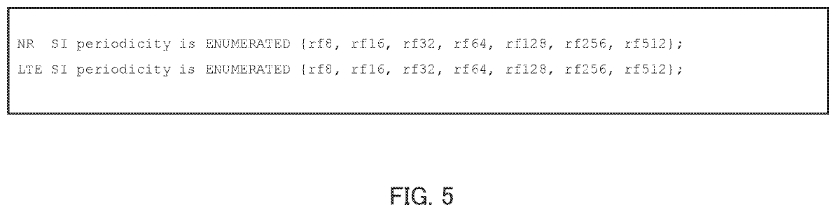

System Information (SI) periodicities illustrated in FIG. 5 are studied for transmission periodicities of SI in NR and LTE. That is, configurations with a minimum of 8 radio frames (80 ms) are studied as the SI periodicities.

In addition, the following scenarios are assumed concerning connection between a UE and a base station:

(Scenario 0) A UE is connected to an NR base station and does not perform Carrier Aggregation (CA) and Dual Connectivity (DC) (NR stand-alone and Non-CA/non-DC).

(Scenario 1) A UE is connected to an LTE base station and an NR base station. In this scenario, there are a case where the LTE base station is a master node (EN-DC) and a case where the NR base station is a master node (NE-DC or NR-EUTRA Dual connectivity). Further, in this scenario, there are a case where the LTE base station is synchronized with the NR base station (Synchronous) and a case where the LTE base station is not synchronized with the NR base station (Asynchronous).

(Scenario 2) A UE is connected to two NR base stations and performs CA and/or DC (NN-CA/DC or NR-NR CA/DC).

In above scenarios 1 and 2, carrier characteristics may differ as follows:
A plurality of carriers used for CA or DC are configured adjacently to one another in a common frequency band (intra-band continuous CA/DC).
A plurality of carriers used for CA or DC are configured to be spaced away from each other in a common frequency band (intra-band non-continuous CA/DC).
A plurality of carriers used for CA or DC are configured in mutually different frequency bands (inter-band non-continuous CA/DC).
Timing advances different between carriers are configured (multiple TA group).

As described above, at the clock synchronization accuracy level “1,” the clock synchronization requirement is less than 1 μs, and the maximum number of devices in one communication group for clock synchronization is 300. In this case, it is conceivable to broadcast time information (e.g., to transmit broadcast information (System Information Block (SIB))) in order to improve resource utilization efficiency. However, no comprehensive study on how UEs obtain the time information broadcast considering the scenarios listed above has been made.

For example, for some UEs, the SIB transmission periodicity in NR is not short enough with respect to the requirement of less than 1 μs for clock synchronization at the clock synchronization accuracy level “1” illustrated in FIG. 4. Next, one example will be described. Let a clock periodicity offset be 32 parts per million (ppm) for a case where Time Sensitive Network (TSN) Grand Master (GM) of stratum-4 or a lower stratum is used. In this case, a time drift in 80 ms is up to 2.56 μs (=80 ms×32/1000000). This time of 80 ms may be a period between two occasions for a UE to receive the SIB and read the time information to perform synchronization correction. This time of 2.56 exceeds 1 μs, which is the clock synchronization requirement in the case of the clock synchronization accuracy level “1” illustrated in FIG. 4. The following method (A1) or (A2) is conceivable as a method for addressing this.

(A1) The time of the UE is updated more frequently by either the SIB or unicast at a periodicity shorter than a predetermined periodicity (e.g., 80 ms).

(A2) Information on a measurement periodicity offset is included in the timing reference information provided to the UE. The measurement periodicity offset is later used by the UE to accurately adjust the timing reference information.

In above method (A1), it is necessary to change the SI periodicity, and the impact on the standards is large. Further, the use of unicast is less resource efficient to support up to 300 UEs indicated in FIG. 4. Further, in above method (A2), it is necessary to define the information on the measurement periodicity offset, and the impact on the standards is large.

Next, methods 1 and 2 will be described as examples of a method for improving the synchronization accuracy of synchronization by the UE to the reference time. Note that method 1 described below is applicable to any of above scenarios 0 to 2. Method 2 is applicable to above scenarios 1 and 2.

### Method 1

Multicast signaling for transmitting timing reference information at a periodicity shorter than a predetermined periodicity (e.g., a periodicity of less than 80 ms) is defined. The multicast signaling may be information transmitted by multicast.

For example, the UE may be configured to receive a UE group/multicast PDSCH in a serving cell. Here, the “UE group/multicast PDSCH” is an example of the designation of a Physical downlink shared channel (PDSCH) received by UEs belonging to a UE group composed of two or more UEs. That is, the UE group/multicast PDSCH is an example of a data channel that carries information to be transmitted (multicast) to the plurality of UEs belonging to the UE group. The “UE group/multicast PDSCH” may be replaced with another term such as “UE group PDSCH” or “multicast PDSCH.”

The UE group/multicast PDSCH may include a Cyclic Redundancy Check (CRC) scrambled with a Radio Network Temporary Identifier (RNTI) commonly configured for the plurality of UEs belonging to the UE group (hereinafter referred to as “UE group RNTI”). For example, method 1 may be implemented by any of the following (B1) to (B3).

(B1) The UE group/multicast PDSCH may be scheduled by a separate Physical downlink control channel (PDCCH). The scheduling information for this PDSCH may be provided by Downlink Control Information (DCI) having the CRC scrambled with the UE group RNTI. In this case, the UE may receive the UE group/multicast PDSCH according to the scheduling.

(B2) Monitoring for the UE group/multicast PDSCH may be activated and deactivated by a PDCCH. In this case, the activation and deactivation of the PDSCH may be indicated by the DCI having the CRC scrambled with the UE group RNTI. Further, in this case, the UE may monitor the UE group/multicast PDSCH at a configured periodicity after activation by the PDCCH until deactivation. Note that the activation/deactivation may be replaced with another term such as enabled/disabled or on/off.

(B3) Monitoring for the UE group/multicast PDSCH may be activated and deactivated by RRC signaling. In this case, the PDCCH and/or DCI may not be involved in the activation and deactivation of monitoring for the PDSCH. Further, in this case, the UE may monitor the group/multicast PDSCH after the activation by the RRC signaling until the deactivation.

Further, in method 1, the UE may not report (or transmit) Hybrid Automatic Repeat Request (HARQ)-acknowledgement (ACK) feedback in response to the UE group/multicast PDSCH. With this configuration, resource utilization efficiency is improved, and processing loads of the base station and the UE are reduced. Since retransmission control for the timing reference information is not so necessary, reporting no HARQ-ACK feedback as described above does not cause any problem. In this configuration, the following (C1) and/or (C2) may also be implemented.

(C1) The UE may be capable of receiving the UE group/multicast PDSCH and a unicast PDSCH at overlapping times in the same serving cell. Here, the UE may report the HARQ-ACK feedback in response to the unicast PDSCH. In this case, the UE may perform reception processing of the UE group/multicast PDSCH and reception processing of the unicast PDSCH in different flows in order to receive the UE group/multicast PDSCH and the unicast PDSCH. In addition, the UE group/multicast PDSCH and the unicast PDSCH may be mapped to resources orthogonal in time and frequency to each other in the same serving cell. Alternatively, the UE group/multicast PDSCH and the unicast PDSCH may also be multiplexed on the same time and frequency resources in the same serving cell. Even in multiplexing on the same time and frequency resources, Demodulation Reference Signals (DM-RSs) included in the UE group/multicast PDSCH and unicast PDSCH may be formed by mutually orthogonal sequences.

(C2) The UE may report capability information (capability signaling) for indicating whether the UE is capable of receiving the UE group/multicast PDSCH and unicast PDSCH at overlapping times in the same serving cell.

In implementation of the above (B1), the following (option 1) or (option 2) can be adopted.

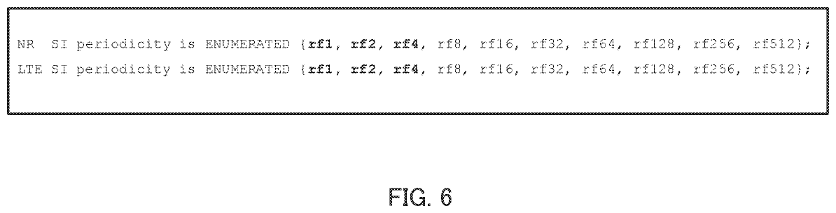

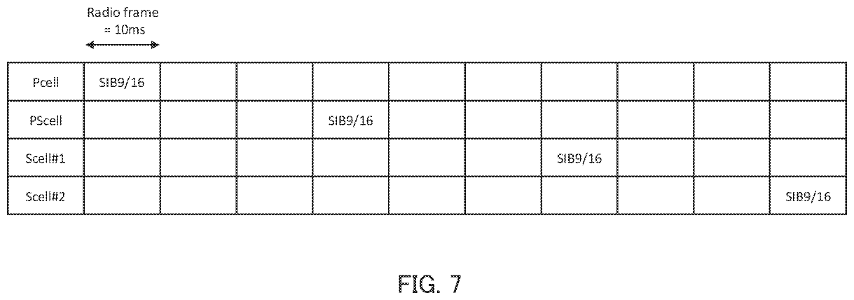

(Option 1) An SIB with a periodicity shorter than a predetermined periodicity (e.g., a periodicity of less than 80 ms) is supported. For example, as illustrated in bold in FIG. 6, the SI in NR and LTE may support at least one periodicity of 10 ms, 20 ms, and 40 ms that are shorter than 80 ms. For example, when the SI periodicity is 10 ms, the time drift is ⅛ of 2.56 μs, which is the time drift for a case where the SI periodicity is 80 ms, and therefore the time synchronization requirement of “less than 1 μs” at the clock synchronization accuracy level “1” is satisfied.

(Option 2) A new UE group/multicast PDSCH different from the SIB is supported. Also in this case, the UE receives an SIB different from the UE group/multicast PDSCH and unicast PDSCH. In addition, the following (D1) and/or (D2) may be implemented:

(D1) The UE may be capable of receiving the SIB and the UE group/multicast PDSCH at overlapping times in the same serving cell.

(D2) The UE may report capability information for informing whether the UE is capable of receiving the SIB and the UE group/multicast PDSCH at overlapping times in the same serving cell.

### Method 2

The UE monitors the SIB or broadcast signaling including the timing reference information in at least two of a plurality of serving cells where carrier aggregation or dual connectivity is performed. Note that the term “Pcell” is an abbreviation for Primary Cell. The term “Scell” is an abbreviation for Secondary Cell. The term “PScell” is an abbreviation for Primary SCell. The broadcast signaling may be information transmitted by broadcast (e.g., timing reference information).

Here, the SIB or broadcast signaling is Time Division Multiplexed (TDMed) across the plurality of serving cells. For example, the transmission periodicity of the SIB including the timing reference information in each of the serving cells is set to 80 ms, and the transmission periodicities of the SIB in the serving cells are shifted. Consequently, the UE obtains the timing reference information across the plurality of serving cells, so as to be capable of receiving the timing reference information at a periodicity shorter than 80 ms. In method 2, at least one of the following (E1), (E2) and (E3) may be performed.

(E1) The UE may be configured to monitor the SIB providing the timing reference information (the SIB is called as SIB9 in NR and SIB16 in LTE, for example, and is denoted as SIB9/16 below) in order to obtain the timing reference information across the plurality of serving cells. For example, as illustrated in FIG. 7, SIB9/16 is transmitted on different occasions in Pcell, PScell, Scell #1, and Scell #2. In this case, the UE monitors SIB9/16 across Pcell, PScell, Scell #1 and Scell #2, so as to be capable of obtaining the timing reference information at a periodicity shorter than a predetermined periodicity (e.g., at a periodicity shorter than 80 ms).

(E2) The UE may not report HARQ-ACK on SIB9/16 in the plurality of serving cells. Note that when a unicast PDSCH is received in any of the serving cells in addition to the reception of SIB9/16, HARQ-ACK for the unicast PDSCH may be reported.

(E3) With respect to the common SIB, broadcast signaling, or multi cast signaling according to method 1, the following (E3-1) or (E3-2) may be implemented when occasions for monitoring overlap across the plurality of serving cells.

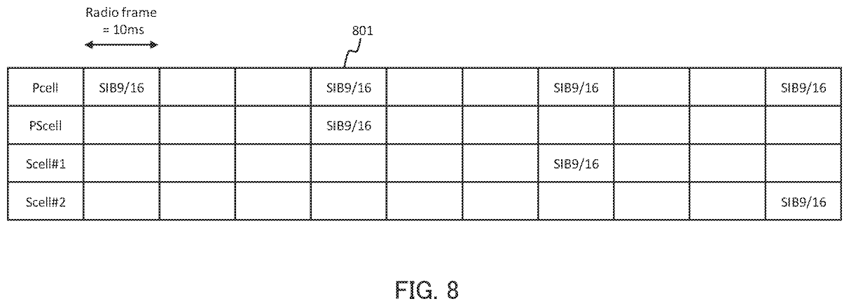

(E3-1) The SIB, broadcast signaling, or multicast signaling according to method 1 of which serving cell to be monitored depends on the UE. For example, when the occasions for monitoring SIB9/16 overlap across Pcell and Pscell as illustrated in column 801 in FIG. 8, SIB9/16 of which cell to be chosen depends on the UE.

(E3-2) The UE may obtain the SIB, broadcast signaling, or multicast signaling according to method 1 from a serving cell having the lowest cell ID among cells in which the occasions overlap. Note that the lowest cell ID may be replaced with the highest cell ID or a specific cell ID.

Note that aforementioned “SIB9/16” is one example of the SIB including the timing reference information. Thus, method 2 is applicable to any system information including the timing reference information. Note also that aforementioned Pcell, PScell, Scell #1, and Scell #2 are examples of the designation of a plurality of cells. Thus, Pcell, PScell, Scell #1, and Scell #2 may also be referred to as the first to the fourth cells, respectively.

### Modifications

Next, a modification of above-described method 2 will be described. Note that the modification is applicable to any of scenarios 0 to 2 described above.

The UE monitors multiple SIBs or broadcast signaling on a serving cell. Here, the SIBs or broadcast signaling are TDMed and Frequency Division Multiplexed (FDMed) on the serving cell. For example, the transmission periodicity of the SIBs including the timing reference information transmitted in subbands of the serving cell is set to 80 ms, and the transmission periodicities of the SIBs are shifted between the subbands. Consequently, the UE obtains the timing reference information across the plurality of subbands, so as to be capable of receiving the timing reference information at a periodicity shorter than 80 ms. Note that the subbands may also be Bandwidth parts (BWPs).

The serving cell may be a serving cell formed from a Pcell, PScell, Scell, or Network (NW).

When a plurality of active subbands (e.g., Bandwidth parts (BWPs)) are supported on the serving cell, the following processing may be performed. That is, the broadcast signaling and/or frequency domain resources for the number of times of broadcast signaling received by the UE may be configured by the NW or determined or derived from the subbands (e.g., BWPs). Here, the frequency domain resources may be configured, for example, by the starting Physical Resource Block (PRB), the ending PRB, or the total number of PRBs.

The periodicity of broadcast signaling for each time may be maintained as a predetermined value (e.g., a periodicity value that can be monitored by a terminal having only Release 15 functions).

Offsets for a plurality of times of broadcast signaling in the time domain may be different from one another. In addition, the offsets may be configured by a higher layer.

In this modification, the following (F1) and/or (F2) may be implemented:

(F1) The UE may be configured to monitor SIB9/16 to obtain timing reference information across a plurality of serving cells.

(F2) The UE may not report HARQ-ACK regarding SIB9/16 in a serving cell.

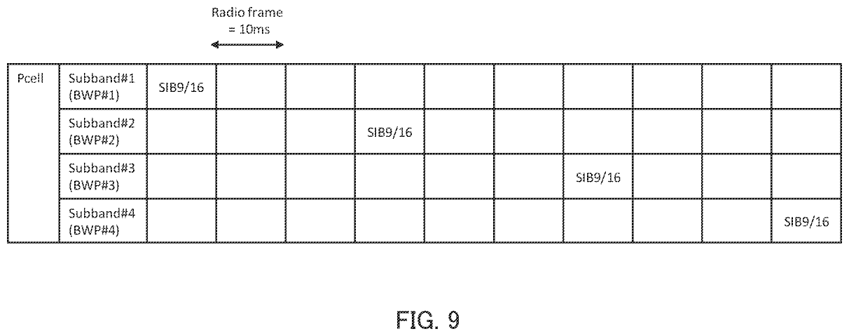

Next, one example of the modification will be described with reference to FIG. 9. For example, subbands #1, #2, #3, and #4 are supported in the Pcell. SIB9/16 is transmitted on mutually different occasions in subbands #1, #2, #3, and #4. In this case, the UE monitors SIB9/16 across subbands #1, #2, #3, and #4 of the Pcell, so as to be capable of obtaining the timing reference information at a periodicity shorter than a predetermined periodicity (e.g., at a periodicity shorter than 80 ms). The Pcell illustrated in FIG. 9 may be replaced with another cell such as Scell or PScell.

Note that the UE may be configured to monitor SIB9/16 in order to obtain the timing reference information across a plurality of cells (see FIG. 7) and a plurality of subbands (see FIG. 9) in at least one of the plurality of cells.

### Summary of Present Disclosure

In the present disclosure, terminal 20 includes reception section 201 that receives timing reference information that is broadcast or multicast at a predetermined periodicity (e.g., a periodicity of less than 80 ms), and control section 203 that adjusts synchronization to reference time based on the timing reference information received by reception section 201. With this configuration, terminal 20 is capable of adjusting the synchronization to the reference time at the predetermined periodicity (e.g., the periodicity of less than 80 ms), so that the synchronization accuracy can be improved (e.g., synchronization accuracy of less than 1 μs).

### Hardware Configuration and/or the Like

Note that the block diagrams used to describe the above embodiment illustrate blocks on a function-by-function basis. These functional blocks (component sections) are implemented by any combination of at least hardware or software. A method for implementing the functional blocks is not particularly limited. That is, the functional blocks may be implemented using one physically or logically coupled apparatus. Two or more physically or logically separate apparatuses may be directly or indirectly connected (for example, via wires or wirelessly), and the plurality of apparatuses may be used to implement the functional blocks. The functional blocks may be implemented by combining software with the one apparatus or the plurality of apparatuses described above.

The functions include, but not limited to, judging, deciding, determining, computing, calculating, processing, deriving, investigating, searching, confirming, receiving, transmitting, outputting, accessing, solving, selecting, choosing, establishing, comparing, supposing, expecting, regarding, broadcasting, notifying, communicating, forwarding, configuring, reconfiguring, allocating, mapping, assigning, and the like. For example, a functional block (component section) that functions to achieve transmission is referred to as “transmission section,” “transmitting unit,” or “transmitter.” The methods for implementing the functions are not limited specifically as described above.

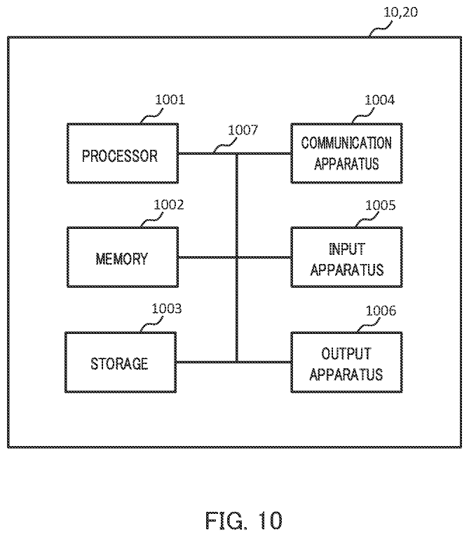

For example, the base station, user terminal, and the like according to an embodiment of the present disclosure may function as a computer that executes processing of a radio communication method of the present disclosure. FIG. 10 illustrates an example of a hardware configuration of the base station and the user terminal according to an embodiment of the present disclosure. Base station 10 and user terminal 20 described above may be physically constituted as a computer apparatus including processor 1001, memory 1002, storage 1003, communication apparatus 1004, input apparatus 1005, output apparatus 1006, bus 1007, and the like.

Note that the term “apparatus” in the following description can be replaced with a circuit, a device, a unit, or the like. The hardware configurations of base station 10 and of user terminal 20 may include one or more of the apparatuses illustrated in the drawings or may not include a part of the apparatuses.

The functions of base station 10 and user terminal 20 are implemented by predetermined software (program) loaded into hardware, such as processor 1001, memory 1002, and the like, according to which processor 1001 performs the arithmetic and controls communication performed by communication apparatus 1004 or at least one of reading and writing of data in memory 1002 and storage 1003.

Processor 1001 operates an operating system to entirely control the computer, for example. Processor 1001 may be composed of a central processing unit (CPU) including an interface with peripheral apparatuses, control apparatus, arithmetic apparatus, register, and the like. For example, control sections 103, 203, and/or the like as described above may be implemented by processor 1001.

Processor 1001 reads a program (program code), a software module, data, and the like from at least one of storage 1003 and communication apparatus 1004 to memory 1002 and performs various types of processing according to the program (program code), the software module, the data, and the like. As the program, a program for causing the computer to perform at least a part of the operations described in the above embodiments is used. For example, control section 203 of user terminal 20 may be implemented using a control program stored in memory 1002 and operated by processor 1001, and the other functional blocks may also be implemented in the same way. While it has been described that the various types of processing as described above are performed by one processor 1001, the various types of processing may be performed by two or more processors 1001 at the same time or in succession. Processor 1001 may be implemented using one or more chips. Note that the program may be transmitted from a network through a telecommunication line.

Memory 1002 is a computer-readable recording medium and may be composed of, for example, at least one of a Read Only Memory (ROM), an Erasable Programmable ROM (EPROM), an Electrically Erasable Programmable ROM (EEPROM), and a Random Access Memory (RAM). Memory 1002 may be called as a register, a cache, a main memory (main storage apparatus), or the like. Memory 1002 can save a program (program code), a software module, and the like that can be executed to carry out the radio communication method according to an embodiment of the present disclosure.

Storage 1003 is a computer-readable recording medium and may be composed of, for example, at least one of an optical disk such as a Compact Disc ROM (CD-ROM), a hard disk drive, a flexible disk, a magneto-optical disk (for example, a compact disc, a digital versatile disc, or a Blu-ray (registered trademark) disc), a smart card, a flash memory (for example, a card, a stick, or a key drive), a floppy (registered trademark) disk, and a magnetic strip. Storage 1003 may also be called as an auxiliary storage apparatus. The storage medium as described above may be, for example, a database, a server, or other appropriate media including at least one of memory 1002 and storage 1003.

Communication apparatus 1004 is hardware (transmission and reception device) for communication between computers through at least one of wired and wireless networks and is also called as, for example, a network device, a network controller, a network card, or a communication module. Communication apparatus 1004 may be configured to include a high frequency switch, a duplexer, a filter, a frequency synthesizer, and the like in order to achieve at least one of Frequency Division Duplex (FDD) and Time Division Duplex (TDD), for example. A transmission/reception section may be implemented with a transmission section and a reception section physically or logically separated from each other.

Input apparatus 1005 is an input device (for example, a keyboard, a mouse, a microphone, a switch, a button, or a sensor) that receives input from the outside. Output apparatus 1006 is an output device (for example, a display, a speaker, or an LED lamp) which makes outputs to the outside. Note that input apparatus 1005 and output apparatus 1006 may be integrated (for example, a touch panel).

The apparatuses, such as processor 1001, memory 1002, and the like are connected by bus 1007 for communication of information. Bus 1007 may be configured using a single bus or using buses different between each pair of the apparatuses.

Furthermore, base station 10 and user terminal 20 may include hardware, such as a microprocessor, a digital signal processor (DSP), an Application Specific Integrated Circuit (ASIC), a Programmable Logic Device (PLD), and a Field Programmable Gate Array (FPGA), and the hardware may implement part or all of the functional blocks. For example, processor 1001 may be implemented using at least one of these pieces of hardware.

### Notification and Signaling of Information

The notification of information is not limited to the aspects or embodiments described in the present disclosure, and the information may be notified by another method. For example, the notification of information may be carried out by one or a combination of physical layer signaling (for example, Downlink Control Information (DCI), Uplink Control Information (UCI)), higher layer signaling (for example, Radio Resource Control (RRC) signaling, Medium Access Control (MAC) signaling, broadcast information (Master Information Block (MIB), System Information Block (SIB))), and other signals. The RRC signaling may be called as an RRC message and may be, for example, an RRC connection setup message, an RRC connection reconfiguration message, or the like.

### Applied System

The aspects and embodiments described in the present disclosure may be applied to at least one of a system using Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (registered trademark), GSM (registered trademark), CDMA2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), or other appropriate systems and a next-generation system extended based on the above systems. Additionally or alternatively, a combination of two or more of the systems (e.g., a combination of at least LTE and LTE-A and 5G) may be applied.

### Processing Procedure and the Like

The orders of the processing procedures, the sequences, the flow charts, and the like of the aspects and embodiments described in the present disclosure may be changed as long as there is no contradiction. For example, elements of various steps are presented in exemplary orders in the methods described in the present disclosure, and the methods are not limited to the presented specific orders.

### Operation of Base Station

Specific operations which are described in the present disclosure as being performed by the base station may sometimes be performed by an upper node depending on the situation. Various operations performed for communication with a terminal in a network constituted by one network node or a plurality of network nodes including a base station can be obviously performed by at least one of the base station and a network node other than the base station (examples include, but not limited to, Mobility Management Entity (MME) or Serving Gateway (S-GW)). Although there is one network node in addition to the base station in the case illustrated above, a plurality of other network nodes may be combined (for example, MME and S-GW).

### Direction of Input and Output

The information or the like (see the item of <Information and Signals>) can be output from a higher layer (or a lower layer) to a lower layer (or a higher layer). The information, the signals, and the like may be input and output through a plurality of network nodes.

### Handling of Input and Output Information and the Like

The input and output information and the like may be saved in a specific place (for example, memory) or may be managed using a management table. The input and output information and the like can be overwritten, updated, or additionally written. The output information and the like may be deleted. The input information and the like may be transmitted to another apparatus.

### Determination Method

The determination may be made based on a value expressed by one bit (0 or 1), based on a Boolean value (true or false), or based on comparison with a numerical value (for example, comparison with a predetermined value).

### Variations and the Like of Aspects

The aspects and embodiments described in the present disclosure may be independently used, may be used in combination, or may be switched and used along the execution. Furthermore, notification of predetermined information (for example, notification indicating “it is X”) is not limited to explicit notification, and may be performed implicitly (for example, by not notifying the predetermined information).

While the present disclosure has been described in detail, it is obvious to those skilled in the art that the present disclosure is not limited to the embodiments described in the present disclosure. Modifications and variations of the aspects of the present disclosure can be made without departing from the spirit and the scope of the present disclosure defined by the description of the appended claims. Therefore, the description of the present disclosure is intended for exemplary description and does not limit the present disclosure in any sense.

### Software

Regardless of whether the software is called as software, firmware, middleware, a microcode, or a hardware description language or by another name, the software should be broadly interpreted to mean an instruction, an instruction set, a code, a code segment, a program code, a program, a subprogram, a software module, an application, a software application, a software package, a routine, a subroutine, an object, an executable file, an execution thread, a procedure, a function, and the like.

The software, the instruction, the information, and the like may be transmitted and received through a transmission medium. For example, when the software is transmitted from a website, a server, or another remote source by using at least one of a wired technique (e.g., a coaxial cable, an optical fiber cable, a twisted pair, and a digital subscriber line (DSL)) and a wireless technique (e.g., an infrared ray and a microwave), the at least one of the wired technique and the wireless technique is included in the definition of the transmission medium.

### Information and Signals

The information, the signals, and the like described in the present disclosure may be expressed by using any of various different techniques. For example, data, instructions, commands, information, signals, bits, symbols, chips, and the like that may be mentioned throughout the entire description may be expressed by one or an arbitrary combination of voltage, current, electromagnetic waves, magnetic fields, magnetic particles, optical fields, and photons.

Note that the terms described in the present disclosure and the terms necessary to understand the present disclosure may be replaced with terms with the same or similar meaning. For example, at least one of the channel and the symbol may be a signal (signaling). The signal may be a message. The component carrier (CC) may be called as a carrier frequency, a cell, a frequency carrier, or the like.

### “System” and “Network”

The terms “system” and “network” used in the present disclosure can be interchangeably used.

### Names of Parameters and Channels

The information, the parameters, and the like described in the present disclosure may be expressed using absolute values, using values relative to predetermined values, or using other corresponding information. For example, radio resources may be indicated by indices.

The names used for the parameters are not limitative in any respect. Furthermore, the formulas and the like using the parameters may be different from the ones explicitly disclosed in the present disclosure. Various channels (for example, PUCCH and PDCCH) and information elements can be identified by any suitable names, and various names assigned to these various channels and information elements are not limitative in any respect.

### Base Station

The terms “Base Station (BS),” “radio base station,” “fixed station,” “NodeB,” “eNodeB (eNB),” “gNodeB (gNB),” “access point,” “transmission point,” “reception point, “transmission/reception point,” “cell,” “sector,” “cell group,” “carrier,” and “component carrier” may be used interchangeably in the present disclosure. The base station may be called as a macro cell, a small cell, a femtocell, or a pico cell.

The base station can accommodate one cell or a plurality of (for example, three) cells. When the base station accommodates a plurality of cells, the entire coverage area of the base station can be divided into a plurality of smaller areas, and each of the smaller areas can provide a communication service based on a base station subsystem (for example, small base station for indoor remote radio head (RRH)). The term “cell” or “sector” denotes part or all of the coverage area of at least one of the base station and the base station subsystem that perform the communication service in the coverage.

### Mobile Station

The terms “Mobile Station (MS),” “user terminal,” “User Equipment (UE),” and “terminal” may be used interchangeably in the present disclosure.

The mobile station may be called, by those skilled in the art, as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or by some other appropriate terms.

### Base Station/Mobile Station

At least one of the base station and the mobile station may be called as a transmission apparatus, a reception apparatus, a communication apparatus, or the like. Note that at least one of the base station and the mobile station may be a device mounted in a mobile entity, the mobile entity itself, or the like. The mobile entity may be a vehicle (e.g., an automobile or an airplane), an unmanned mobile entity (e.g., a drone or an autonomous vehicle), or a robot (a manned-type or unmanned-type robot). Note that at least one of the base station and the mobile station also includes an apparatus that does not necessarily move during communication operation. For example, at least one of the base station and the mobile station may be Internet-of-Things (IoT) equipment such as a sensor.

The base station in the present disclosure may also be replaced with the user terminal. For example, the aspects and the embodiments of the present disclosure may find application in a configuration that results from replacing communication between the base station and the user terminal with communication between multiple user terminals (such communication may, e.g., be referred to as device-to-device (D2D), vehicle-to-everything (V2X), or the like). In this case, user terminal 20 may be configured to have the functions that base station 10 described above has. The wordings “uplink” and “downlink” may be replaced with a corresponding wording for inter-equipment communication (for example, “side”). For example, an uplink channel, a downlink channel, and the like may be replaced with a side channel. Similarly, the user terminal in the present disclosure may he replaced with the base station. In this case, base station 10 is configured to have the functions that user terminal 20 described above has.

### Meaning and Interpretation of Terms

As used herein, the term “determining” may encompass a wide variety of actions. For example, “determining” may be regarded as judging, calculating, computing, processing, deriving, investigating, looking up, searching (or, search or inquiry) (e.g., looking up in a table, a database or another data structure), ascertaining and the like. Furthermore, “determining” may be regarded as receiving (for example, receiving information), transmitting (for example, transmitting information), inputting, outputting, accessing (for example, accessing data in a memory) and the like. Also, “determining” may be regarded as resolving, selecting, choosing, establishing, comparing and the like. That is, “determining” may be regarded as a certain type of action related to determining. Also, “determining” may be replaced with “assuming,” “expecting,” “considering,” and the like.

The terms “connected” and “coupled” as well as any modifications of the terms mean any direct or indirect connection and coupling between two or more elements, and the terms can include cases in which one or more intermediate elements exist between two “connected” or “coupled” elements. The coupling or the connection between elements may be physical or logical coupling or connection or may be a combination of physical and logical coupling or connection. For example, “connected” may be replaced with “accessed.” When the terms are used in the present disclosure, two elements can be considered to be “connected” or “coupled” to each other using at least one of one or more electrical wires, cables, and printed electrical connections or using electromagnetic energy with a wavelength of a radio frequency domain, a microwave domain, an optical (both visible and invisible) domain, or the like that are non-limiting and non-inclusive examples.

### Reference Signal

The reference signal can also be abbreviated as the RS and may also be called as a pilot depending on the applied standard.

### Meaning of “Based On”

The description “based on” used in the present disclosure does not mean “based only on,” unless otherwise specified. In other words, the description “based on” means both of “based only on” and “based at least on.”

### Terms “First” and “Second”

Any reference to elements by using the terms “first,” “second,” and the like that are used in the present disclosure does not generally limit the quantities of or the order of these elements. The terms can be used as a convenient method of distinguishing between two or more elements in the present disclosure. Therefore, reference to first and second elements does not mean that only two elements can be employed, or that the first element has to precede the second element somehow.

### “Means”

The “means” in the configuration of each apparatus described above may be replaced with “section,” “circuit,” “device,” or the like.

### Open-Ended Format

In a case where terms “include,” “including,” and their modifications are used in the present disclosure, these terms are intended to be inclusive like the term “comprising.” Further, the term “or” used in the present disclosure is not intended to be an exclusive or.

### Time Units such as a TTI, Frequency Units such as an RB, and a Radio Frame Configuration

The radio frame may be constituted by one frame or a plurality of frames in the time domain. The one frame or each of the plurality of frames may be called as a subframe in the time domain.

The subframe may be further constituted by one slot or a plurality of slots in the time domain, The subframe may have a fixed time length (e.g., 1 ms) independent of numerology.

The numerology may be a communication parameter that is applied to at least one of transmission and reception of a certain signal or channel. The numerology, for example, indicates at least one of SubCarrier Spacing (SCS), a bandwidth, a symbol length, a cyclic prefix length, a Transmission Time Interval (TTI), the number of symbols per TTI, a radio frame configuration, specific filtering processing that is performed by a transmission and reception apparatus in the frequency domain, specific windowing processing that is performed by the transmission and reception apparatus in the time domain, and the like.

The slot may be constituted by one symbol or a plurality of symbols (e.g., Orthogonal Frequency Division Multiplexing (OFDM) symbol(s), Single Carrier-Frequency Division Multiple Access (SC-FDMA) symbol(s), or the like) in the time domain. The slot may also be a time unit based on the numerology.

The slot may include a plurality of mini-slots. Each of the mini-slots may be constituted by one or more symbols in the time domain. Furthermore, the mini-slot may be referred to as a subslot. The mini-slot may be constituted by a smaller number of symbols than the slot. A PDSCH (or PUSCH) that is transmitted in the time unit that is greater than the mini-slot may be referred to as a PDSCH (or PUSCH) mapping type A. The PDSCH (or PUSCH) that is transmitted using the mini-slot may be referred to as a PDSCH (or PUSCH) mapping type B.

The radio frame, the subframe, the slot, the mini slot, and the symbol indicate time units in transmitting signals. The radio frame, the subframe, the slot, the mini slot, and the symbol may be called by other corresponding names.

For example, one subframe, a plurality of continuous subframes, one slot, or one mini-slot may be called as a Transmission Time Interval (TTI). That is, at least one of the subframe and the TTI may be a subframe (1 ms) in the existing LTE, a duration (for example, 1 to 13 symbols) that is shorter than 1 ms, or a duration that is longer than 1 ms. Note that a unit that represents the TTI may be referred to as a slot, a mini-slot, or the like instead of a subframe.

Here, the TTI, for example, refers to a minimum time unit for scheduling in radio communication. For example, in an LTE system, the base station performs scheduling for allocating a radio resource (a frequency bandwidth, a transmit power, and the like that are usable in each user terminal) on a TTI-by-TTI basis to each user terminal. Note that the definition of TTI is not limited to this.

The TTI may be a time unit for transmitting a channel-coded data packet (a transport block), a code block, or a codeword, or may be a unit for processing such as scheduling and link adaptation. Note that when the TTI is assigned, a time section (for example, the number of symbols) to which the transport block, the code block, the codeword, or the like is actually mapped may be shorter than the TTI.

Note that in a case where one slot or one mini-slot is referred to as the TTI, one or more TM (that is, one or more slots or one or more mini-slots) may be a minimum time unit for the scheduling. Furthermore, the number of slots (the number of mini-slots) that make up the minimum time unit for the scheduling may be controlled.

A TTI that has a time length of 1 ms may be referred to as a usual TTI (a TTI in LTE Rel. 8 to LTE Rel. 12), a normal TTI, a long TTI, a usual subframe, a normal subframe, a long subframe, a slot, or the like. A TTI that is shorter than the usual TTI may be referred to as a shortened TTI, a short TTI, a partial TTI (or a fractional TTI), a shortened subframe, a short subframe, a mini-slot, a subslot, a slot, or the like.

Note that the long TTI (for example, the usual TTI, the subframe, or the like) may be replaced with a TTI that has a time length which exceeds 1 ms, and the short TTI (for example, the shortened TTI or the like) may be replaced with a TTI that has a TTI length which is less than a TTI length of the long TTI and is equal to or longer than 1 ms.

A resource block (RB) is a resource allocation unit in the time domain and the frequency domain, and may include one or more contiguous subcarriers in the frequency domain. The number of subcarriers that are included in the RB may be identical regardless of the numerology, and may be 12, for example. The number of subcarriers that are included in the RB may be determined based on the numerology.

In addition, the RB may include one symbol or a plurality of symbols in the time domain, and may have a length of one slot, one mini slot, one subframe, or one TTI. One TTI and one subframe may be constituted by one resource block or a plurality of resource blocks.

Note that one or more RBs may be referred to as a Physical Resource Block (PRB), a Sub-Carrier Group (SCG), a Resource Element Group (REG), a PRB pair, an RB pair, or the like.

In addition, the resource block may be constituted by one or more Resource Elements (REs). For example, one RE may be a radio resource region that is one subcarrier and one symbol.

A bandwidth part (BWP) (which may be referred to as a partial bandwidth or the like) may represent a subset of contiguous common resource blocks (RB) for a certain numerology in a certain carrier. Here, the common RBs may be identified by RB indices that use a common reference point of the carrier as a reference. The PRB may be defined by a certain BWP and may be numbered within the BWP. The BWP may include a UL BWP and a DL BWP. An UE may be configured with one or more BWPs within one carrier.

At least one of the configured BWPs may be active, and the UE does not have to assume transmission/reception of a predetermined signal or channel outside the active BWP. Note that “cell,” “carrier,” and the like in the present disclosure may be replaced with “BWP.”

Structures of the radio frame, the subframe, the slot, the mini-slot, the symbol, and the like are described merely as examples. For example, the configuration such as the number of subframes that are included in the radio frame, the number of slots per subframe or radio frame, the number of mini-slots that are included in the slot, the numbers of symbols and RBs that are included in the slot or the mini-slot, the number of subcarriers that are included in the RB, the number of symbols within the TTI, the symbol length, the Cyclic Prefix (CP) length, and the like can be changed in various ways.

### Maximum Transmit Power

The “maximum transmit power” described in the present disclosure may mean a maximum value of the transmit power, the nominal UE maximum transmit power, or the rated UE maximum transmit power.

### Article

In a case where articles, such as “a,” “an,” and “the” in English, for example, are added in the present disclosure by translation, nouns following these articles may have the same meaning as used in the plural.

### “Different”

In the present disclosure, the expression “A and B are different” may mean that “A and B are different from each other.” Note that the expression may also mean that “A and B are different from C.” The expressions “separated” and “coupled” may also be interpreted in the same manner as the expression “A and B are different.”

### INDUSTRIAL APPLICABILITY

One aspect of the present disclosure is useful for radio communication systems.

### REFERENCE SIGNS LIST

10, 10a, 10b Base station
20, 20a, 20b Terminal
101 Transmission section
102 Reception section
103 Control section
201 Reception section
202 Transmission section
203 Control section

1. A terminal, comprising:
a reception section that receives time information that is periodically broadcast or multicast; and
a control section that adjusts synchronization to reference time based on the time information.

2. The terminal according to claim 1, wherein the reception section receives the time information on a downlink data channel for a group to which a plurality of the terminals belong.

3. The terminal according to claim 1, wherein the reception section receives the time information that is broadcast or multicast on occasions in at least two cells, the occasions being different between the at least two cells.

4. The terminal according to claim 1, wherein the reception section receives the time information that is broadcast or multicast on occasions in at least two subbands, the occasions being different between the at least two subbands.

5. The terminal according to claim 1, wherein the control section does not transmit a response to the reception of the time information.

6. A communication method, comprising the following performed by a terminal:
receiving time information that is periodically broadcast or multicast; and
performing control to adjust synchronization to reference time based on the time information.

7. The terminal according to claim 2, wherein the control section does not transmit a response to the reception of the time information.

8. The terminal according to claim 3, wherein the control section does not transmit a response to the reception of the time information.

9. The terminal according to claim 4, wherein the control section does not transmit a response to the reception of the time information.
